(19) United States
(12) Patent Application Publication
(10) Pub. No.: US 2019/0346956 A1
(43) Pub. Date: Nov. 14, 2019

(54) TOUCH DISPLAY

(71) Applicant: HEWLETT-PACKARD DEVELOPMENT COMPANY, L.P., Spring, TX (US)

(72) Inventors: Steven Steinmark, Fort Collins, CO (US); Fred Charles Thomas III, Fort Collins, CO (US); Jonathan D. Bassett, Fort Collins, CO (US); Bruce E. Blaho, Fort Collins, CO (US)

(73) Assignee: HEWLETT-PACKARD DEVELOPMENT COMPANY, L.P., Spring, TX (US)

(21) Appl. No.: 16/463,274

(22) PCT Filed: Feb. 3, 2017
(86) PCT No.: PCT/US2017/016387

§ 371 Date: May 22, 2019

(51) Int. Cl. G06F 3/041; G02F 1/1333

(52) U.S. Cl. CPC G06F 3/0412; G02F 2202/28; G06F 2203/04103; G02F 1/13338

(57) ABSTRACT

In example implementations, a touch display and methods for producing the same is provided. The touch display includes a touch display cover glass, a liquid crystal module, a touch sensor and an emissive dot film. The touch sensor may be located between the touch display cover glass and the liquid crystal module. The emissive dot film may be optically bonded to the touch sensor and located between the touch display cover glass and the liquid crystal module.

### BACKGROUND

Electronic devices use a touch display to provide a more intuitive user interface and improve the overall user experience, Touch displays allow a user to use his or her finger, or a pointing device, to manipulate images on the touch display. For example, the user can touch an area of the screen to make a selection, enlarge an image using his or her finger tips, move items on the touch display with his or her fingertip, and the like.

Certain applications use a touch display that has a higher positional accuracy or sensitivity. This may be in contrast to some touch displays which may have a larger tolerance to accommodate larger fingertips of a user and allow a user to touch a relatively large area. For example, for certain graphics applications detecting precise location of where the pointing device or fingertip lands on the screen can improve the user experience.

### BRIEF DESCRIPTION OF THE DRAWINGS

FIG. 1 is a block diagram of an example device of the present disclosure;

FIG. 2 is a block diagram of an example touch display of the present disclosure:

FIG. 3 is a block diagram of another example touch display of the present disclosure; and

FIG. 4 is a block diagram of an example method for producing a touch display of the present disclosure.

### DETAILED DESCRIPTION

The present disclosure discloses a touch display and methods for producing the same. As discussed above, electronic devices use a touch display to provide a more intuitive user interface and improve the overall user experience. Touch displays allow a user to use his or her finger, or a pointing device, to manipulate images on the touch display. One type of point device that can be used is an electro-optical pen. The electro-optical pen may convert light signals emitted by the electro-optical pen or a display device into an electric signal. The electric signal can be used by a device in communication with the electro-optical pen to provide location information, generate a mark on the display device (e.g., writing a line or text), and the like.

Some touch display designs use a touch sensor that is layered on top of the display cover glass. However, the touch sensor is unprotected and can be easily damaged. For example, the touch sensor can be damaged by fingertips or the electro-optical pen.

Other touch display designs have included a custom liquid crystal module (LCM) display panel or an addition of multiple emissive layers to provide background emissivity and pattern contrast. The LCM display may be customized by having the multi-layered emissive dot film background design include a custom irradiance scattering hot mirror, or near infrared (NIR) reflective layer, behind an infrared (IR) absorbing layer.

Other designs include customizing the LCM display with elements in the LCM stack construction that may provide for a diffuse emission of the NIR irradiance. This adds expensive and custom elements to the design. The display may have an altered aesthetic off-color or non-pure black appearance in these designs and have high costs due to the customizations.

The examples of the present disclosure provide a touch display that uses a single layer emissive dot film that can be used with non-custom LCM panels (e.g., LCM panels that do not use the multi-layered emissive dot film background design that includes a custom irradiance scattering hot mirror or NIR reflective layer, behind an IR absorbing layer, as described above). An emissive dot film may comprise a printed pattern of dots. The dots may have a non-repeating pattern that can be used be electro-optical pens to determine location information on the touch display. In one embodiment, the emissive dot film may include quantum dots that may emit light that can be read by the electro-optical pen. In other words, “emissive dot film” may be defined to mean that visibility for the dots is provided by a contrast, whereby the dots, or pattern of dots, emit irradiance or light at a greater level than the background to the dots or the pattern of dots. This background may be understood to be the display without this pattern of dots in front of it. The emission can be provided by several mechanisms, including but not limited to, reflection, retro-reflection, fluorescence, phosphorescence, as well a solid state band-gap electron transitions with associated photon emissions (e.g., quantum dots). One example implementation may be diffuse near-infrared irradiance reflection whereby an external source (LED) irradiates the pattern of dots and that irradiance in part may be reflected in a multiplicity of directions (diffusely) including back at the source.

Optical bonding can be used with the single layer emissive dot film to work with any panel and integrate the single layer emissive dot film into the display stack, while at the same time a reducing, or eliminating, parallax errors.

In addition, the emissive dot film uses a pattern of diffusively reflective dots on the film rather than a multi-layer or custom LCM base solution. Thus, the single layer emissive dot film appears more transparent to the user of the display and has a more pleasant aesthetic than the multi-layered emissive dot film. In contrast, the custom LCM panels discussed above may have an altered aesthetic off-color or non-pure black appearance. As a result, the touch display of the present disclosure is easier to build, has a lower cost and has less visual artifacts.

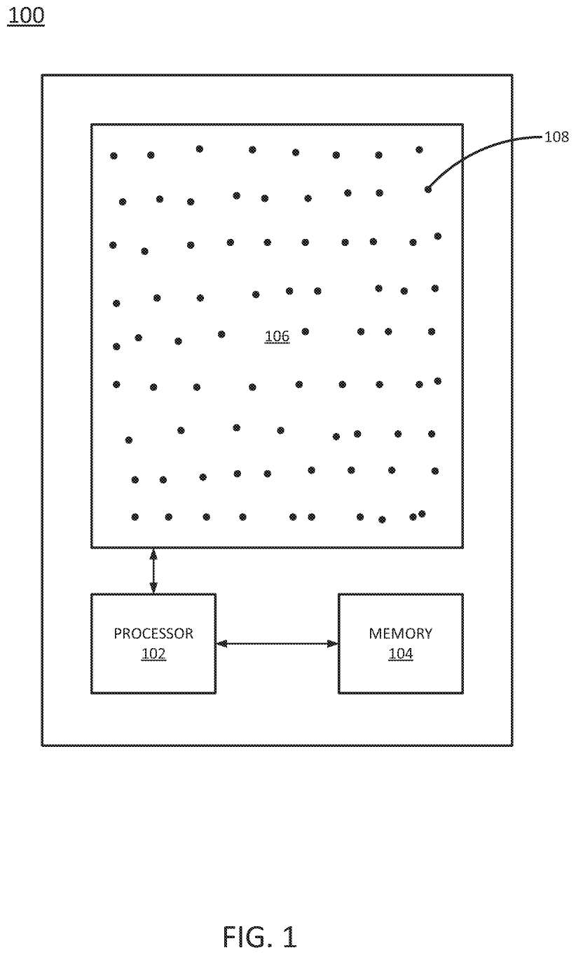

FIG. 1 illustrates a block diagram of an example device 100 of the present disclosure. The device 100 may be a touch screen device, such as for example, a smart phone, a tablet computer, a laptop computer, and the like.

In one example, the device 100 may include a processor 102, a memory 104 and a touch display 106. The memory 104 may be a non-transitory computer readable storage medium that stores instructions that are executed by the processor 102 to perform various functions or operations. For example, the functions or operations may be to control operation of the touch display 106.

In one implementation, the touch display 106 may include a single layer emissive dot film 108. The single layer emissive dot film 108 may include a plurality of dots that can be arranged in a varying, or non-repeating, pattern as described above. The pattern and sizes of each dot of the single layer emissive dot film 108 may vary.

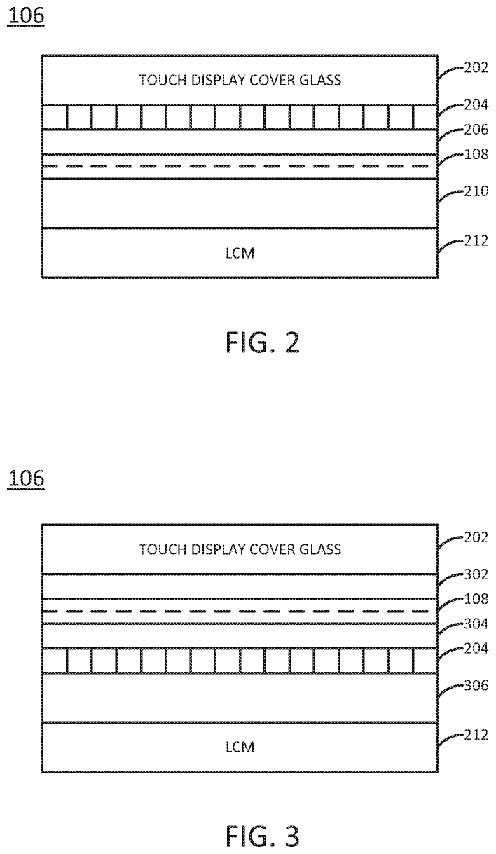

FIG. 2 illustrates a cross sectional view of one example of the touch display 106. In one example, the touch display 106 may include a touch display cover glass 202, a touch sensor 204, the emissive dot film 108 and a liquid crystal module (LCM) 212. In one implementation, the touch display cover glass 202 may be a glass, a plastic, quartz, or any other visible transmissive element. In one example, the touch display cover glass 202 and the touch sensor 204 may be separate components as shown in FIG. 2, or the touch display cover glass 202 and the touch sensor 204 may be integrated as a single component. For example, the touch display cover glass 202 and the touch sensor may be part of a combined touch sensor glass assembly.

In one example, the emissive dot film 108 may be positionally encoded. The LCM 212 may be any type of display producing element including, but not limited to, a liquid crystal display (LCD), an electroluminescent display (ELD), an electronic paper (e.g., E-ink), a plasma display panel (PDP), an organic light-emitting diode (©LED) display, and the like. The touch sensor 204 and the emissive dot film 108 may be located between the touch display cover glass and the LCM 212.

In one example, the touch sensor 204 may be any type of resistive, capacitive, or other touch sensitive rendering sensor. The LCM 212 may provide the liquid crystal display device along with associated integrated circuitry, controllers and back lights to provide the display.

In one example, the emissive dot film 108 may include a single layer. In other words, no additional layers are used with the emissive dot film 108 of the present disclosure. As noted above, other touch display designs may use multiple emissive layers that include a custom irradiance scattering hot mirror, or NIR reflective layer, behind an IR absorbing layer. In contrast, the present disclosure uses a single layer emissive dot film 108.

The emissive dot film 108 may include a flexible polymer film with a pattern of diffusively reflective dots. In other words, as opposed to specular reflection that reflects a ray of light at just one angle per Snell's law, a diffusively reflective dot may reflect light such that an incident ray of light is reflected at many angles. As a result, an ideal diffusively reflective dot may have equal luminance from all directions which lie in a hemispherical space adjacent to the surface of the diffusively reflective dot. In the context of the present disclosure diffuse reflection may mean to reflect in a multiplicity of directions beyond that predicted for specular reflection by Snell's Law and including reflection back at the irradiating source.

The diffusively reflective dots or circles may be approximately 100 microns in diameter. However, it should be noted that the diffusively reflective dots or circles may be any size depending on a particular application. In one implementation, the pattern of diffusively reflective dots may be a grid. The dimensions of the grid and the spacing of the reflective dots may be a function of a particular application. For example, the more complex the encoded geometric pattern of the diffusively reflective dots and the more dense the spacing between the reflective dots, the more gradation and accuracy in detecting where the touch display 106 is being sensed and by extension actuated (e.g., touched).

Notably, the emissive dot film 108 comprises a single layer. In addition, the emissive dot film 108 can be combined with any type of touch display cover glass 202 and LCM 212. In other words, the emissive dot film 108 may work without customization of the LCM.

In one implementation, optical bonding may be used to allow the emissive dot film 108 to work with the touch display cover glass 202. In one example, optical bonding may be defined as using an optically clear adhesive that achieves a desired optical property such as index-of-refraction matching with adjacent layers to the optical bond. Further explanation of optical bonding and how optical bonding is performed is discussed in further detail below. For example, the touch display 204 may be coupled to the touch display cover glass 202. An optical bonding layer 206 may optically bond the emissive dot film 108 to the touch sensor 204. A second optical bonding layer 210 may optically bond the emissive dot film 208 to the LCM 212.

Mechanisms for optical bonding may include adhesives in both liquid (LOCA—liquid optically clear adhesive) and film form (OCA—optically clear adhesive) with the primary basis for their chemistry being silicone or acrylic compositions. Curing methods may include thermal, ultra-violet light exposure with both of these methods being assisted by applied pressure and vacuum (e.g., autoclave).

In other words, the emissive dot film 108 may be optically bonded between the touch sensor 204 and the LCM 212. Said another way, there may be an optical bond above and below the emissive dot film 108 (e.g., the optical bonding layer 206 above the emissive dot film 108 and the optical bonding layer 210 below the emissive dot film 108).

The optical bonding layers 206 and 210 may be optically clear layers (e.g., free of any bubbles, dirt, gels, or any other type of optical distortion) fabricated from an optically clear material, such as for example, an adhesive film, an optically clear adhesive (OCA), a liquid optically clear adhesive (LOCA), a highly viscous optically clear resin (OCR), and the like. In one implementation, the materials chosen for the optical bonding layers 206 and 210 may be based on an index of refraction that is approximately the same as an index of refraction as a layer that is being optically bonded to the emissive dot film 108. For example, the material for the optical bonding layer 206 may be selected to have an index of refraction that is approximately the same as the touch display cover glass 202. The material for the optical bonding layer 210 may be selected to have an index of refraction that is approximately the same as a cover material of the LCM 212 (e.g., a glass or a plastic panel).

If the index of refraction is the same for the different layers within the touch display 106, then the optical bonding layers 206 and 210 may be fabricated from the same materials. If the index of refraction is different for different layers within the touch display 106, the optical bonding layers 206 and 210 may be fabricated from different materials. Selection of the optical bonding layers 206 and 210 may also be a function of the fabricators equipment type and process preferences for this operation.

Selecting the materials with the correct index of refraction for the optical bonding layers 206 and 210 helps to reduce or eliminate display glare, cosmetic defects (e.g., scratches), parallax errors, and the like. Differences in index of refraction between layers will setup light reflections at these interfaces and create obtrusive reflective glare from the display. Scratches in the bonded layer can be wetted or indexed out with use of optical bonding layer coincident with the surface with such defects (scratches, divots, etc.). Parallax error may cause the apparent position of an object to be different between the touch display cover glass 202 and the emissive dot film 108 when the index of refraction changes. For example, if the correct materials were not selected for the optical bonding layers 206 and 210, or no optical bonding layers 206 and 210 were used at all, the emissive dot film 208 may not accurately read where an electro-optical stylus/pen is touching, or contacting, the touch display cover glass 202. In other words, the optical bonding layers 206 and 210 may help to reduce index transitions in the emissive dot film 108 and associated positional location translation errors by using the optical bonding layers 206 and 210 that are index matched on both sides of the emissive dot film 108.

In one example, having an index of refraction that is approximately the same may mean having an index of refraction that is close enough to eliminate glare, cosmetic defects or parallax errors. For example, the respective index of refraction for an optical bonding layer and a layer being bonded to the emissive dot film 108 may not be identical, but may be close enough that glare, cosmetic defects or parallax errors may be eliminated.

Moreover, the optical bonding layers 206 and 210 may eliminate any air gaps between the touch sensor 204 and the emissive dot film 108 or the LCM 212 and the emissive dot film 108. Air between the layers can cause visual artifacts (e.g., glare and cosmetic defects) and parallax error because of the different index of refraction of air. Thus, the present disclosure provides a touch display 106 that uses the optical bonding layers 206 and 210 to remove, or reduce, parallax errors and visual artifacts. The proper selection of materials for the optical bonding layers 206 and 210 also provides compatibility of the emissive dot film 108 with any type of panel or touch display cover glass 202. Eliminating the use of custom panels helps to reduce the overall cost of the touch display 106 and help improve the ease of producing the touch display 106 by reducing fabrication complexity of the touch display 106.

It should be noted that although FIG. 2 illustrates a particular arrangement, different arrangements may also be deployed. For example, the emissive dot film 108 may be optically bonded between the touch sensor 204 and the touch display cover glass 202, as illustrated in FIG. 3.

FIG. 3 illustrates a cross-sectional view of another arrangement of layers of the touch display 106. The touch display 106 may include the touch display cover glass 202, the emissive dot film 108, the touch sensor 204 and the LCM 212. The touch display 106 in FIG. 3, may include at least two optical bonding layers 302 and 304 coupled to the emissive dot film 108 to optically bond the emissive dot film 108 between the touch display cover glass 202 and the LCM 212.

For example, the optical bonding layer 302 may optically bond the emissive dot film 208 to the touch display cover glass 202. The optical bonding layer 304 may optically bond the emissive dot film 108 to the touch sensor 204. A third optical bonding layer 306 may optically bond the touch sensor 204 to the LCM 212.

Thus, as can be seen between FIGS. 2 and 3 that the order of the emissive dot film 108 and the touch sensor 204 may be interchangeable. In other words, the emissive dot film 108 may be optically bonded to the touch sensor 204 and additional optical bonding layers may be deployed depending on the order of the touch sensor 204 and the emissive dot film 208.

It should be noted that the dimensions (e.g., area and thickness) of each layer in FIGS. 2 and 3 may be a function of a particular application. For example, the area may depend on a display size of the device 100. The thickness of touch display cover glass 202 may range from approximately a fraction of a millimeter to a few millimeters. The thickness of the optical bonding layers 206, 210, 302, 304 and 306 may be a function of the type of material and how much adhesive is used to bond two different layers of the touch display 106.

It should be noted that FIGS. 2 and 3 have been simplified for ease of explanation and may include additional layers not shown in the stack. For example, FIGS. 2 and 3 may include additional layers such as privacy film, antiglare film, brightness enhancement film, and the like.

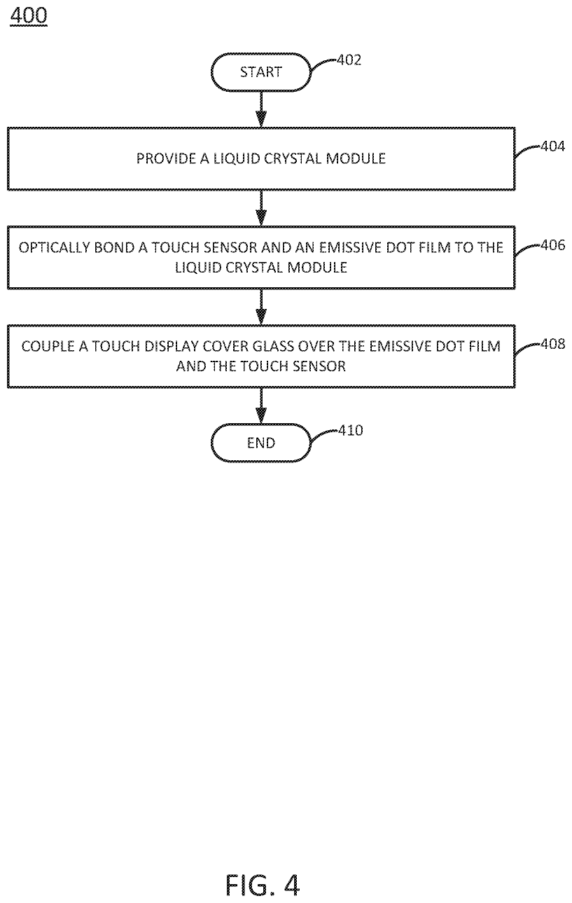

FIG. 4 illustrates a flow diagram of an example method 400 for producing the touch display 106. In one example, the method 400 may be performed by at least one machine in an automated production line controlled by a processor or central controller.

At block 402, the method 400 begins. At block 404, the method 400 provides a liquid crystal module. For example, an assembled liquid crystal module including a liquid crystal display, integrated circuits, a controller, backlighting (e.g., light emitting diodes (LEDs)), circuit boards, and the like may be provided.

At block 406, the method 400 optically bonds a touch sensor and an emissive dot film to the liquid crystal module. For example, an optically clear adhesive, a liquid optically clear adhesive, or an optically clear resin may be used to form optical bonding layers. The material selected to optically bond the touch sensor and the emissive dot film to the liquid crystal module may be a function of an index of refraction. In other words, the material that forms the optical bonding layers may be selected to have a same index of refraction as one of the layers being bonded, or have an index intermittent to the bonded layers that reduces the transitional step in index between layers to reduce or eliminate visual artifacts and parallax errors.

In one implementation, the touch sensor may be optically bonded to the liquid crystal module and then the emissive dot film may be optically bonded to the touch sensor. In another implementation, the emissive dot film may be optically bonded to the liquid crystal module and then the touch sensor may be optically bonded to the emissive dot film.

At block 408, the method 400 couples a touch display cover glass over the emissive dot film and the touch sensor. For example, the touch display cover glass may be coupled directly to the touch sensor or may be optically bonded to the emissive dot film depending on a sequence of the touch sensor and the emissive dot film. The completed touch display may then be installed into a computing device or touch screen device. At block 410, the method 400 ends.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A touch display, comprising:
a touch display cover glass;
a liquid crystal module;
a touch sensor between the touch display cover glass and the liquid crystal module; and
an emissive dot film optically bonded to the touch sensor and located between the touch display cover glass and the liquid crystal module.

2. The touch display of claim 1, wherein the emissive dot film is optically bonded between the touch sensor and the liquid crystal module.

3. The touch display of claim 1, wherein the emissive dot film is optically bonded between the touch display cover glass and the touch sensor.

4. The touch display of claim 1; wherein a first optical bonding layer forms a first optical bond above the emissive dot film and a second optical bonding layer forms a second optical bond below the emissive dot film.

5. The touch display of claim 4, wherein the optical bonding layer comprises an optically clear adhesive, a liquid optically clear adhesive, or an optically clear resin.

6. The touch display of claim 4, wherein the optical bonding layer and the emissive dot film have a respective index of refraction that are approximately equal.

7. A method, comprising:
providing a liquid crystal module;
optically bonding a touch sensor and an emissive dot film to the liquid crystal module; and
coupling a touch display cover glass over the emissive dot film and the touch sensor.

8. The method of claim 7, comprising:
optically bonding the emissive dot film to the liquid crystal module; and
optically bonding the touch sensor to the emissive dot film.

9. The method of claim 7, comprising:
optically bonding the touch sensor to the liquid crystal module;
optically bonding the emissive dot film to the touch sensor; and
optically bonding the display cover glass to the emissive dot film.

10. The method of claim 7, wherein optically bonding comprises adding an optically clear layer comprising at least one of: an optically clear adhesive, a liquid optically clear adhesive, or an optically clear resin.

11. The method of claim 10, wherein the optically clear layer and the emissive dot film have a respective index of refraction that are approximately equal.

12. A touch display, comprising:
a touch display cover glass;
a liquid crystal module;
a touch sensor between the touch display cover glass and the liquid crystal module:
an emissive dot film coupled to the touch sensor and located between the touch display cover glass and the liquid crystal module; and
at least two optical bonding layers coupled to the emissive dot film to optically bond the emissive dot film between the touch display cover glass and the liquid crystal module.

13. The touch display of claim 12, wherein a first optical bonding layer of the at least two optical bonding layers optically bonds the emissive dot film to the touch sensor and a second optical bonding layer of the at least two optical bonding layers optically bonds the emissive dot film to the liquid crystal module.

14. The touch display of claim 12, wherein a first optical bonding layer of the at least two optical bonding layers optically bonds the emissive dot film to the touch display glass and a second optical bonding layer of the at least two optical bonding layers optically bonds the emissive dot film to the touch sensor.

15. The touch display of claim 14, wherein a third optical bonding layer optically bonds the touch sensor to the liquid crystal module.
